(19) United States
(12) Patent Application Publication
(10) Pub. No.: US 2025/0316163 A1
(43) Pub. Date: Oct. 9, 2025

(54) ESTIMATING LANE-LEVEL TRAFFIC JAM DYNAMICS USING VEHICLE GPS DATA

(71) Applicant: Toyota Motor Engineering & Manufacturing North America, Inc., Plano, TX (US)

(72) Inventors: Yashar Zeiynali Farid, San Jose, CA (US); Emrah Akin Sisbot, Menlo Park, CA (US); Divya Sai Toopran, San Jose, CA (US); Kentaro Oguchi, Sunnyvale, CA (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 18/627,963

(22) Filed: Apr. 5, 2024

(51) Int. Cl. G08G 1/01; G01C 21/36

(52) U.S. Cl. CPC G08G 1/0133; G01C 21/3691; G08G 1/0112

(57) ABSTRACT

A method may include receiving driving data from a plurality of vehicles within a sampling region. The driving data may include speeds, positions, and lane change activity of the plurality of vehicles. The method may further include identifying first locations of one or more back of queue samples based on the driving data. The method may further include identifying second locations of one or more front of queue samples based on the driving data. The method may further include performing cluster analysis on the first locations and the second locations. The method may further include identifying one or more back of queue clusters and one or more front of queue clusters based on the cluster analysis. The method may further include determining a number of lane-level traffic jams within the sampling region based on the number of back of queue clusters and the number of front of queue clusters.

### TECHNICAL FIELD

The present specification relates to traffic monitoring, and more particularly, to estimating lane-level traffic jam dynamics using vehicle GPS data.

### BACKGROUND

Lane-level traffic, in which average speeds of vehicles in different lanes of a road vary significantly, can lead to traffic congestion, and may increase traffic accidents. As such, it may be desirable to determine dynamics of lane-level traffic such that drivers and/or autonomous vehicles can navigate accordingly. However, GPS data from vehicles may not be accurate enough to determine which lane a vehicle is driving in, and lane-level data from vehicles may not be readily available. As such, a need exists for methods of estimating lane-level traffic jam dynamics using vehicle GPS data.

### SUMMARY

In an embodiment, a method may include receiving driving data from a plurality of vehicles within a sampling region. The driving data may include speeds, positions, and lane change activity of the plurality of vehicles. The method may further include identifying first locations of one or more back of queue samples based on the driving data. The method may further include identifying second locations of one or more front of queue samples based on the driving data. The method may further include performing cluster analysis on the first locations and the second locations. The method may further include identifying one or more back of queue clusters and one or more front of queue clusters based on the cluster analysis. The method may further include determining a number of lane-level traffic jams within the sampling region based on the number of back of queue clusters and the number of front of queue clusters.

In another embodiment, a computing device may include one or more processors. The processors may receive driving data from a plurality of vehicles within a sampling region. The driving data may include speeds, positions, and lane change activity of the plurality of vehicles. The processors may identify first locations of one or more back of queue samples based on the driving data. The processors may identify second locations of one or more front of queue samples based on the d based on the driving data. The processors may perform cluster analysis on the first locations and the second locations. The processors may identify one or more back of queue clusters and one or more front of queue clusters based on the cluster analysis. The processors may determine a number of lane-level traffic jams within the sampling region based on the number of back of queue clusters and the number of front of queue clusters.

In another embodiment, a system may include a computing device and a plurality of vehicles. The plurality of vehicles may transmit driving data to the computing device. The driving data may include speeds, positions, and lane change activity of the plurality of vehicles. The computing device may include one or more processors. The processors may identify first locations of one or more back of queue samples based on the driving data. The processors may identify second locations of one or more front of queue samples based on the d based on the driving data. The processors may perform cluster analysis on the first locations and the second locations. The processors may identify one or more back of queue clusters and one or more front of queue clusters based on the cluster analysis. The processors may determine a number of lane-level traffic jams within the sampling region based on the number of back of queue clusters and the number of front of queue clusters

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts a system for detecting lane-level traffic using connected vehicle data without lane identification information, according to one or more embodiments shown and described herein;

FIG. 2 schematically depicts the cloud server of FIG. 1, according to one or more embodiments shown and described herein;

FIG. 3 depicts an example vehicle approaching a traffic jam, according to one or more embodiments shown and described herein;

FIG. 4 depicts an example vehicle approaching a traffic jam, according to one or more embodiments shown and described herein;

FIG. 5 depicts example back of queue samples, according to one or more embodiments shown and described herein;

FIG. 6 depicts example front of queue samples, according to one or more embodiments shown and described herein;

FIG. 7 depicts example back of queue clusters, according to one or more embodiments shown and described herein;

FIG. 8 depicts example front of queue clusters, according to one or more embodiments shown and described herein;

FIG. 9 depicts example back of queue clusters and an example front of queue clusters, according to one or more embodiments shown and described herein;

FIG. 10 depicts example traffic jams, according to one or more embodiments shown and described herein;

FIG. 11 depicts an example back of queue clusters and example front of queue clusters, according to one or more embodiments shown and described herein;

FIG. 12 depicts example traffic jams, according to one or more embodiments shown and described herein;

FIG. 13 depicts an example back of queue clusters and an example front of queue cluster, according to one or more embodiments shown and described herein;

FIG. 14 depicts example traffic jams in adjacent lanes, according to one or more embodiments shown and described herein;

FIG. 15 depicts a vehicle changing lanes between example traffic jams in adjacent lanes, according to one or more embodiments shown and described herein;

FIG. 16 depicts mean positions of an example back of queue cluster and example front of queue clusters, according to one or more embodiments shown and described herein;

FIG. 17 depicts a flowchart of a method that may be performed by the cloud server of FIGS. 1 and 2, according to one or more embodiments shown and described herein; and

FIG. 18 depicts a flowchart of another method that may be performed by the cloud server of FIGS. 1 and 2, according to one or more embodiments shown and described herein.

### DETAILED DESCRIPTION

The embodiments disclosed herein include a method and system for estimating lane-level traffic jam dynamics using vehicle GPS data. As vehicles drive along a multi-lane road, traffic jams may occur in different lanes of the road. In some cases, a traffic jam may occur in one lane but not another lane, which is referred to herein as lane-level traffic. In particular, as used herein, lane-level traffic indicates a situation where the average speed of vehicles in one lane of a road is substantially different from the average speed of vehicles in another lane of the road. More specifically, lane-level traffic may indicate a situation in which the average speed of vehicles in one lane of a road in a particular region varies by more than a threshold amount from the average speed of vehicles in another lane of the road within the particular region.

When lane-level traffic occurs, it may lead to inefficient or dangerous driving conditions. As such, it may be desirable to detect lane-level traffic. In particular, it may be desirable to estimate lane-level traffic dynamics, such as how many lanes of traffic contain a traffic jam and the positions and average speeds of each such traffic jam. If lane-level traffic dynamics can be estimated, drivers and autonomous vehicles may be warned about the lane-level traffic. As such, these drivers or autonomous vehicles may plan a navigation route in consideration of the lane-level traffic dynamics. For example, a driver may avoid an area that has lane-level traffic or may change lanes before reaching the lane-level traffic.

Many modern vehicles are connected vehicles, meaning they are able to transmit and/or receive data to or from external computing devices (e.g., other vehicles, traffic infrastructure, edge servers, or a cloud server). As such, if a cloud server or other computing device receives driving data from a number of connected vehicles, the cloud server may use the received driving data to determine traffic information based on the aggregated driving data. However, while many vehicles are able to receive GPS data indicating their positions, GPS data is often noisy and not accurate enough to determine in which lane of a road a vehicle is located. As such, determining lane-level traffic directly from GPS data may not be possible.

In embodiments disclosed herein, a cloud server may estimate lane-level traffic dynamics using connected vehicle data that does not include lane identification information. In embodiments, the cloud server may receive driving data from connected vehicles within a sampling region. The driving data may include positions, speeds, and lane change activity of the connected vehicles. However, the driving data does not include an indication of which lane a connected vehicle is in.

After receiving the driving data from a plurality of connected vehicles within the sampling region, the cloud server may determine locations where a vehicle reached a rear position or a front position of a vehicle queue based on changes in vehicle speed, as disclosed herein. For example, when a vehicle reaches the back of a vehicle queue, the vehicle may suddenly decelerate. Similarly, when a vehicle reaches the front of a vehicle queue, the vehicle may suddenly accelerate.

After identifying a plurality of back of queue samples and front of queue samples, the cloud server may perform cluster analysis to identify back of queue clusters and front of queue clusters. The cloud server may then identify one or more vehicle queues based on the cluster analysis. The cloud server may then identify the positions and average speeds of lane-level vehicle queues.

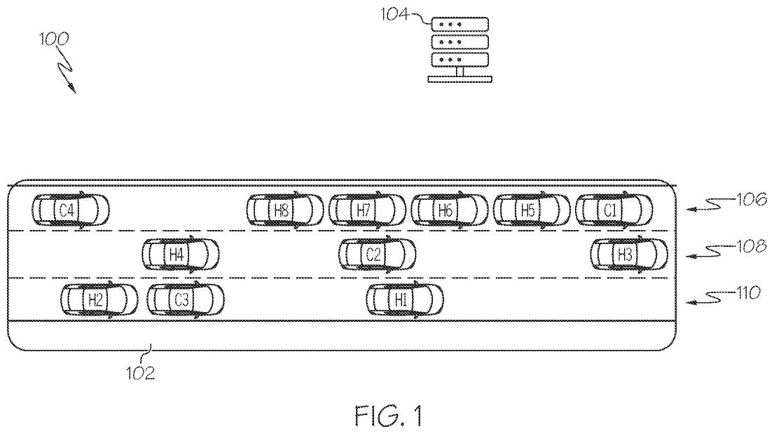

Turning now to the figures, FIG. 1 schematically depicts a system for estimating lane-level traffic jam dynamics, as disclosed herein. In the example of FIG. 1, a system 100 includes a plurality of vehicles traveling along a road 102 and a cloud server 104.

In the example of FIG. 1, the road 102 includes three lanes 106, 108, and 110 along which a plurality of vehicles are driving, including some connected vehicles and some non-connected vehicles. In the example of FIG. 1, connected vehicles C1 and C4, and non-connected vehicles H5, H6, H7, and H8 are driving in lane 106; connected vehicle C2 and non-connected vehicles H3 and H4 are driving in lane 108; and connected vehicle C3 and non-connected vehicles H1 and H2 are driving in lane 110.

As shown in FIG. 1, lane-level traffic is present in lane 106. That is, vehicles C1, H5, H6, H7, and H8 form a vehicle queue in lane 106, while there are no vehicle queues in lanes 108 or 110. Accordingly, the system 100 may estimate dynamics of such lane-level traffic using the techniques described herein.

In the example of FIG. 1, the connected vehicles C1-C4 may transmit driving data to the cloud server 104. That is, the connected vehicles C1-C4 may gather data about their driving behavior using one or more sensors (e.g., position, speed, driving direction, and lane-change activity), and may periodically transmit this data to the cloud server 104 (e.g., every second). In some examples, the connected vehicles C1-C4 may transmit other vehicle data to the cloud server 104 (e.g., wheel angle data).

In the illustrated example, each connected vehicle only transmits data about its own driving behavior to the cloud server 104. However, in other examples, one or more of the connected vehicles C1-C4 may use external sensors to collect driving data about other vehicles (e.g., one or more of the non-connected vehicles H1-H8). For example, connected vehicle C3 may use a LiDAR sensor to collect driving data about nearby non-connected vehicles H2 and H4. In these examples, connected vehicles that gather driving data about other vehicles may transmit this data to the cloud server 104 as well. This may provide more data for the cloud server 104 to use when detecting lane-level traffic.

The connected vehicles C1-C4 may also receive data from the cloud server 104. For example, the connected vehicles C1-C4 may receive traffic data from the cloud server 104, including information about lane-level traffic jam dynamics determined by the cloud server 104. As such, a human driver of a connected vehicle may use the received information to adjust their driving behavior.

In addition, one or more of the connected vehicles C1-C4 may be an autonomous or semi-autonomous vehicle. That is, one or more of the connected vehicles C1-C4 may autonomously perform some or all driving tasks without intervention by a human driver. As such, a connected vehicle that is autonomous may receive information about lane-level traffic jam dynamics from the cloud server 104 and a vehicle system may control the vehicle to autonomously adjust the driving behavior of the vehicle, as disclosed in further detail below.

In the example of FIG. 1, the cloud server 104 may receive data from the connected vehicles C1-C4, as discussed above. The connected vehicles C1-C4 may be communicatively coupled to the cloud server 104 such that the connected vehicles C1-C4 and the cloud server 104 may transmit data between each other. In some examples, the cloud server 104 may be replaced with an edge server or another computing device.

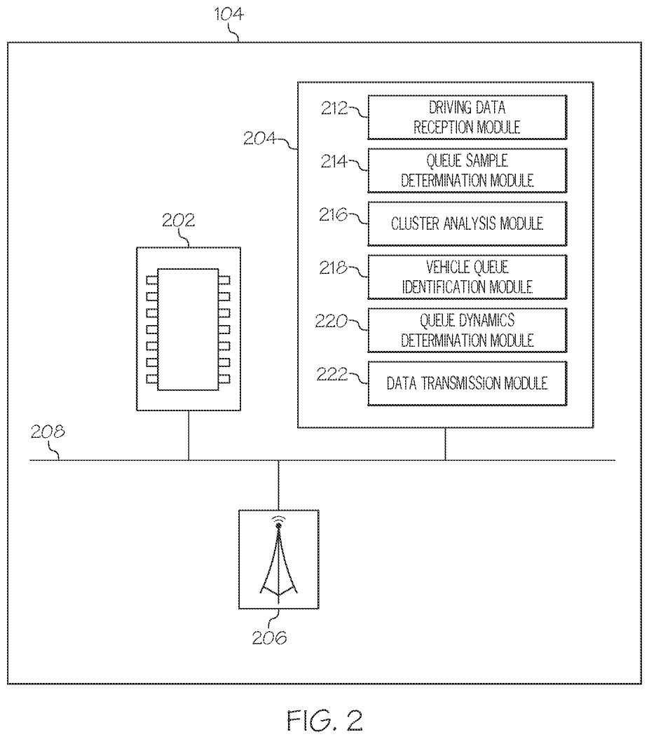

Now referring to FIG. 2, the cloud server 104 comprises one or more processors 202, one or more memory modules 204, network interface hardware 206, and a communication path 208. The one or more processors 202 may be a controller, an integrated circuit, a microchip, a computer, or any other computing device. The one or more memory modules 204 may comprise RAM, ROM, flash memories, hard drives, or any device capable of storing machine readable and executable instructions such that the machine readable and executable instructions can be accessed by the one or more processors 202.

The network interface hardware 206 can be communicatively coupled to the communication path 208 and can be any device capable of transmitting and/or receiving data via a network. Accordingly, the network interface hardware 206 can include a communication transceiver for sending and/or receiving any wired or wireless communication. For example, the network interface hardware 206 may include an antenna, a modem, LAN port, Wi-Fi card, WiMax card, mobile communications hardware, near-field communication hardware, satellite communication hardware and/or any wired or wireless hardware for communicating with other networks and/or devices. The network interface hardware 206 of the cloud server 104 may transmit and receive data to and from the connected vehicles of FIG. 1.

The one or more memory modules 204 include a driving data reception module 212, a queue sample determination module 214, a cluster analysis module 216, a vehicle queue identification module 218, a queue dynamics determination module 220, and a data transmission module 222. Each of the driving data reception module 212, the queue sample determination module 214, the cluster analysis module 216, the vehicle queue identification module 218, the queue dynamics determination module 220, and the data transmission module 222 may be a program module in the form of operating systems, application program modules, and other program modules stored in the one or more memory modules 204. Such a program module may include, but is not limited to, routines, subroutines, programs, objects, components, data structures and the like for performing specific tasks or executing specific data types as will be described below.

The driving data reception module 212 may receive driving data from a plurality of vehicles within a sampling region. The sampling region may be a portion of a road. In some examples, the sampling region may comprise a fixed distance (e.g., 1000 feet). In other examples, the sampling region may vary based on the location of connected vehicles along a road. In the example of FIG. 1, the driving data reception module 212 may receive driving data from the connected vehicles C1, C2, C3, and C4. In embodiments, the driving data reception module 212 may continually receive driving data from connected vehicles (e.g., every 10 seconds).

The driving data received by the driving data reception module 212 may include speeds, positions, driving directions, and lane change activity of the plurality of vehicles. For example, each connected vehicle within the sampling region may transmit data about itself to the cloud server 104, which may be received by the driving data reception module 212. A speed of a connected vehicle received by the driving data reception module 212 may include a current speed of the connected vehicle (e.g., as measured by a vehicle speedometer). In some examples, the driving data reception module 212 may directly receive speed data from connected vehicles. In other examples, the driving data reception module 212 may receive other vehicle data (e.g., GPS data) and may determine vehicle speed based on the received data.

A position of a connected vehicle received by the driving data reception module 212 may include a current position of the connected vehicle (e.g., as measured by a GPS receiver in the vehicle). Lane change activity of a connected vehicle received by the driving data reception module 212 may include an indication of a time and/or a position at which the vehicle performed a lane change. In some examples, the driving data reception module 212 may receive wheel angle data from a connected vehicle, and the cloud server 104 may determine whether the connected vehicle is performing a lane change based on the wheel angle data (e.g., whether the wheel angle exceeds a predetermined threshold).

When the driving data reception module 212 receives vehicle data from connected vehicles, the driving data reception module 212 may store identification information associated with each vehicle sending data. For example, each connected vehicle may transmit a vehicle ID to the cloud server 104. As such, the cloud server 104 may store vehicle data and vehicle IDs associated with the received vehicle data.

Referring still to FIG. 2, the queue sample determination module 214 may determine back of queue samples and front of queue samples based on the driving data received by the driving data reception module 212, as disclosed herein. As discussed above, the driving data reception module 212 may continually receive driving data about vehicles within the sampling region. The driving data may include vehicle positions, vehicle speeds, and lane change activity. The queue sample determination module 214 may then determine samples or data points indicating when a vehicle has reached a back of a vehicle queue and when a vehicle has reached a front of a vehicle queue, as disclosed herein.

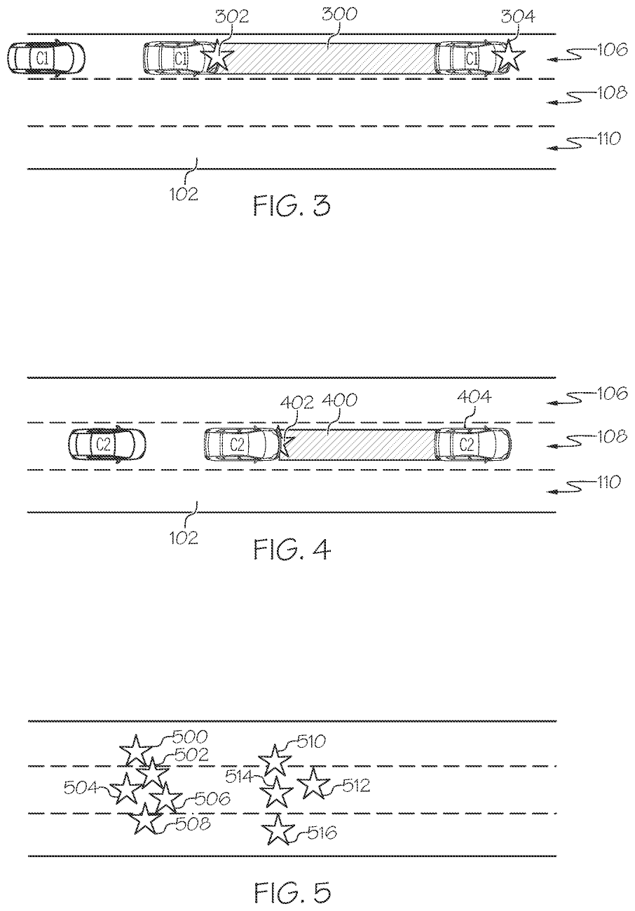

FIG. 3 shows an example in which a vehicle C1 approaches a traffic jam 300 located in lane 106 of the road 102. While FIG. 3 depicts the traffic jam 300 is in lane 106, the vehicle C1 may not have lane-level information such as information that the traffic jam 300 is in lane 106 or that the vehicle C1 is driving in lane 106. As used herein, a traffic jam and a vehicle queue may be used interchangeably. The vehicles in the traffic jam 300 travel slower than other vehicles on the road that are not in the traffic jam. As such, as the vehicle C1 approaches the traffic jam, the vehicle C1 will be traveling at a higher rate of speed than the vehicles in the traffic jam. Accordingly, when the vehicle C1 reaches the back of the traffic jam, the vehicle C1 must reduce its speed to match the speed of the vehicles in the traffic jam. Accordingly, the location where the speed of the vehicle C1 is so reduced may be identified as a back of queue sample. As used herein, a back of queue sample is a data point indicating the location of a back or rear portion of a vehicle queue. In the example of FIG. 3, a back of queue sample 302 is shown.

In embodiments, the queue sample determination module 214 may identify a back of queue sample as a location where a vehicle speed decreases below a threshold value. In some examples, the threshold may be a fixed value (e.g., 30 MPH). In some examples, the threshold may be a value relative to a speed limit of the road on which the vehicle is traveling (e.g., 70% of the speed limit). In some examples, the threshold may be a value relative to the average speed of vehicles traveling along the road, based on the driving data received by the driving data reception module 212 (e.g., 60% of the average vehicle speed).

In some examples, the queue sample determination module 214 may identify a back of queue sample as a location where a vehicle speed decreases from above a first threshold (e.g., 60 MPH) to below a second threshold (e.g., 40 MPH) within a threshold amount of time (e.g., 10 seconds). This may show that the vehicle speed has decreased significantly in a short period of time, which may indicate that the vehicle has reached the back of a traffic jam and must slow down accordingly. In some examples, the queue sample determination module 214 may identify a back of queue sample as a location where a vehicle speed decreases by more than a threshold amount (e.g., 15 MPH) or by more than a threshold percentage (e.g., 20%), within a threshold amount of time.

In addition to back of queue samples, the queue sample determination module 214 may also identify front of queue samples. In the example of FIG. 3, a front of queue sample 304 may indicate when the vehicle C1 has reached the front of the traffic jam 300. Accordingly, the vehicle C1 may begin to increase its speed, having reached the front of the traffic jam.

In embodiments, the queue sample determination module 214 may identify a front of queue sample as a location where a vehicle speed increases above a threshold value. In some examples, the threshold may be a fixed value (e.g., 50 MPH). In some examples, the threshold may be a value relative to a speed limit of the road on which the vehicle is traveling (e.g., 90% of the speed limit). In some examples, the threshold may be a value relative to the average speed of vehicles traveling along the road, based on the driving data received by the driving data reception module 212 (e.g., 80% of the average vehicle speed).

In some examples, the queue sample determination module 214 may identify a front of queue sample as a location where a vehicle speed increases from below a first threshold (e.g., 40 MPH) to above a second threshold (e.g., 60 MPH) within a threshold amount of time (e.g., 10 seconds). This may show that the vehicle speed has increased significantly in a short period of time, which may indicate that the vehicle has reached the front of a traffic jam and can now accelerate freely. In some examples, the queue sample determination module 214 may identify a front of queue sample as a location where a vehicle speed increases by more than a threshold amount (e.g., 15 MPH) or by more than a threshold percentage (e.g., 20%), within a threshold amount of time.

FIG. 4 shows another example in which vehicle C2 approaches a traffic jam 400 in lane 108 of the road 102. While FIG. 4 depicts the traffic jam 400 is in lane 108, the vehicle C2 may not have lane-level information such as information that the traffic jam 400 is in lane 108 or that the vehicle C2 is driving in lane 108. The queue sample determination module 214 may identify a back of queue sample 402 when the vehicle C2 reaches the rear of the traffic jam 400, and a front of queue sample 404 when the vehicle C2 reaches the front of the traffic jam 400. Based on the back of queue sample 302 and the front of queue sample 304, it may be estimated that a traffic jam is present between the locations of samples 302 and 304. Similarly, based on the back of queue sample 402 and the front of queue sample 404, it may be estimated that a traffic jam is present between the locations of samples 402 and 404. However, because the cloud server 104 is unaware of which lanes the vehicles C1 and C2 are driving in, it is unclear whether the traffic jam experienced by the vehicle C1 is the same as the traffic jam experienced by the vehicle C2. As such, further analysis is needed, as discussed in further detail below.

Referring back to FIG. 2, the cluster analysis module 216 may perform cluster analysis on the back of queue samples and the front of queue samples identified by the queue sample determination module 214, as disclosed herein. As disclosed herein, the driving data reception module 212 may continually receive driving data from vehicles within a sampling region, and the queue sample determination module 214 may identify back of queue samples and front of queue samples. In embodiments, the cluster analysis module 216 may perform cluster analysis on all of the back of queue samples and front of queue samples recorded within a certain time period (e.g., 10 minutes).

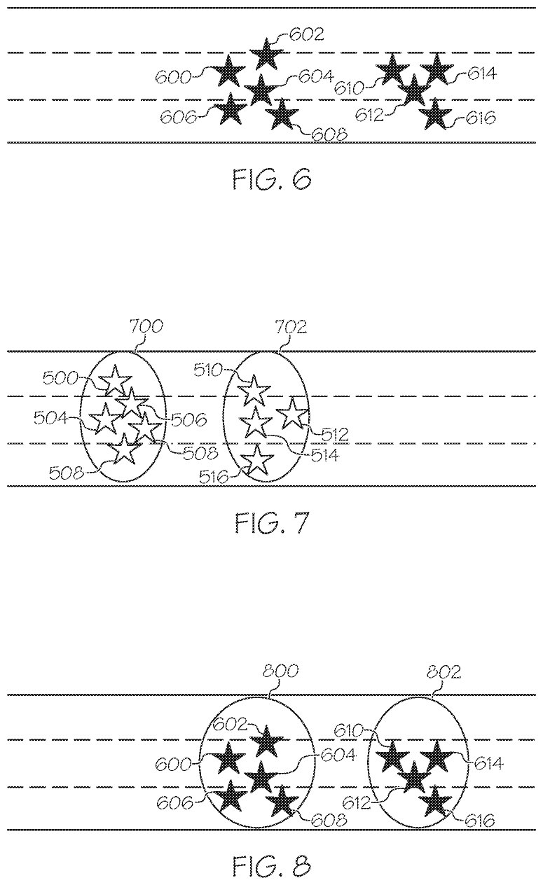

FIG. 5 shows a plurality of back of queue samples 500, 502, 504, 506, 508, 510, 512, 514, and 516 that may be identified by the queue sample determination module 214. FIG. 6 shows a plurality of front of queue samples 600, 602, 604, 606, 608, 610, 612, 614, and 616 that may be identified by the queue sample determination module 214. The cluster analysis module 216 may identify one or more clusters of back of queue samples and one or more clusters of front of queue samples, as disclosed herein.

One challenge in performing the cluster analysis is determining how many clusters should be identified. In one example, the cluster analysis module 216 may perform K-means clustering with various numbers of clusters. For each potential number of clusters, the cluster analysis module 216 may determine a Silhouette score. The cluster analysis module 216 may then determine the number of clusters having the highest Silhouettes core.

In another example, the cluster analysis module 216 may fit Gaussian Mixture Models with various numbers of clusters. For each potential Gaussian Mixture Model, the cluster analysis module 216 may calculate an Akaike Information Criterion. The cluster analysis module 216 may then determine the number of clusters for the Gaussian Mixture Model having the highest Akaike Information criterion.

After determining the number of back of queue clusters and the number of front of queue clusters, the cluster analysis module 216 may identify one or more back of queue clusters containing back of queue samples identified by the queue sample determination module 214 one or more front of queue clusters containing front of queue samples identified by the queue sample determination module 214. FIG. 7 shows an example in which the cluster analysis module 216 identifies back of queue cluster 700 containing back of queue samples 500, 502, 504, 506, and 508, and identifies back of queue cluster 702 containing back of queue samples 510, 512, 514, and 516. FIG. 8 shows an example in which the cluster analysis module 216 identifies front of queue cluster 800 containing front of queue samples 600, 602, 604, 606, and 608, and identifies front of queue cluster 802 containing front of queue samples 610, 612, 614, and 616.

Referring back to FIG. 2, the vehicle queue identification module 218 may identify one or more traffic jams based on the cluster analysis performed by the cluster analysis module 216, as disclosed herein. The number of traffic jams will be greater than or equal to the maximum of the number of identified back of queue clusters and the number of identified front of queue clusters, as disclosed herein.

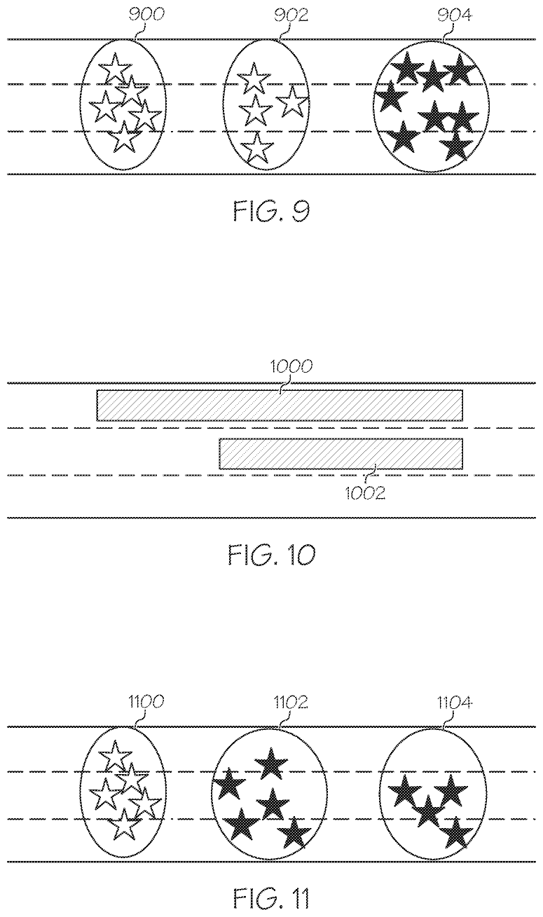

FIG. 9 shows an example in which the cluster analysis module 216 identifies two back of queue clusters 900 and 902, and one front of queue cluster 904. This indicates that there are likely two traffic jams in two different lanes starting at different locations and ending at the same location. In particular, FIG. 10 shows an example in which one traffic jam 1000 spans from back of queue cluster 900 to front of queue cluster 904, and another traffic jam 1002 spans from back of queue cluster 902 to front of queue cluster 904.

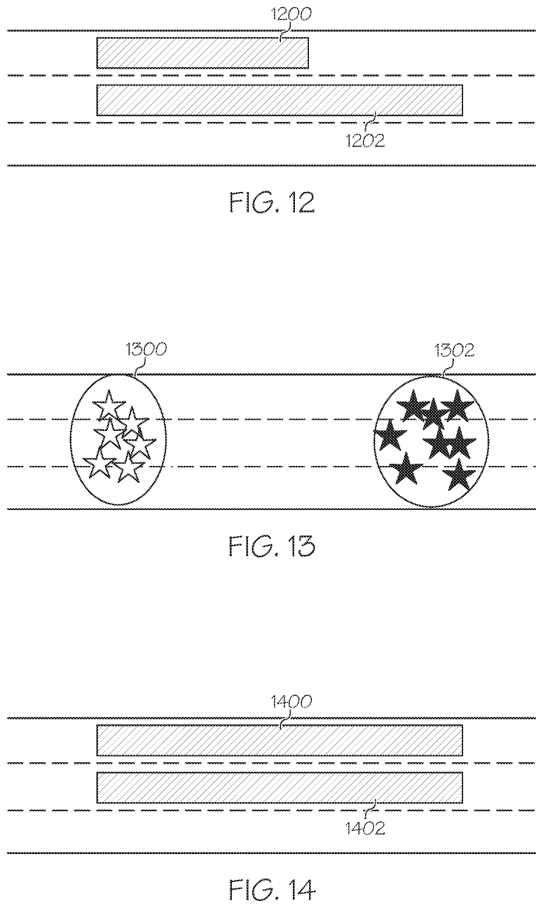

FIG. 11 shows an example in which the cluster analysis module 216 identifies one back of queue cluster 1100, and two front of queue clusters 1102 and 1104. This indicates that there are likely two traffic jams in two different lanes starting at the same location and ending at different locations. In particular, FIG. 12 shows an example in which one traffic jam 1200 spans back of queue cluster 1100 to front of queue cluster 1102, and another traffic jam 1202 spans from back of queue cluster 1100 to front of queue cluster 1104.

As such, in embodiments, the vehicle queue identification module 218 may identify a number of traffic jams in a number of lanes equal to the maximum of the number of identified back of queue clusters and the number of identified front of queue clusters. However, it is also possible that a traffic jam occurs in two adjacent lanes of a road that both start and end in the same location. For example, FIG. 13 shows a situation in which the cluster analysis module 216 has identified one back of queue clusters 1300 and one front of queue cluster 1302. This may indicate that there is one lane-level traffic jam. However, it may also be the case that this indicates two lane-level traffic jams in adjacent lanes. For example, in FIG. 14, there are two traffic jams 1400 and 1402 in adjacent lanes that both start and end at the same position. Accordingly, the vehicle queue identification module 218 may consider lane change information when determining a number of lane-level traffic jams.

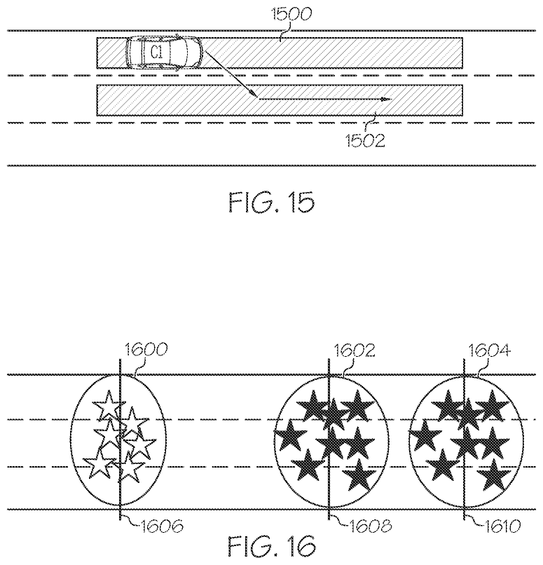

FIG. 15 shows an example in which a vehicle C1 that is in a traffic jam 1500 changes lanes into a traffic jam 1502. As such, in embodiments, the driving data reception module 212 may receive lane change activity, as discussed above. The lane change activity received by the driving data reception module 212 may indicate locations at which connected vehicles in the sampling region perform lane changes. In addition, the driving data received by the driving data reception module 212 may indicate a speed of a vehicle before a lane change and a speed of a vehicle after a lane change.

If a vehicle changes lanes out of a traffic jam, the vehicle's speed is expected to increase after the lane change as the vehicle will no longer be in a traffic jam in the adjacent lane. Alternatively, if a vehicle changes lanes into a traffic jam, the vehicle's speed is expected to decrease after the lane change as the vehicle will be entering the traffic jam. However, if a vehicle that is traveling at a speed below a threshold (e.g., at a slow speed indicating the vehicle is in a traffic jam) changes lanes and continues to travel at a speed below the threshold, this may indicate that the vehicle has gone from a traffic jam in one lane into a traffic jam in an adjacent lane.

As such, in embodiments, the vehicle queue identification module 218 may determine if a vehicle traveling below a threshold speed changes lanes and continues to travel below the threshold speed. In particular, the vehicle queue identification module 218 may determine whether a vehicle performs a lane change from a position between a back of queue cluster and a front of queue cluster while driving below a threshold speed, and after performing the lane change, continues to drive below the threshold speed for at least a threshold amount of time (e.g., 2 seconds). When this occurs, the vehicle queue identification module 218 may determine that two traffic jams are present in two adjacent lanes at the location where the vehicle performed the lane change. More specifically, the vehicle queue identification module 218 may determine that each of the traffic jams in the two adjacent lanes span from the same back of queue cluster to the same front of queue cluster.

Referring back to FIG. 2, the queue dynamics determination module 220 may determine dynamics of each vehicle queue identified by the vehicle queue identification module 218. In particular, the queue dynamics determination module 220 may estimate rear positions, front positions, and average speeds of each identified vehicle queue, as disclosed herein.

In embodiments, after the vehicle queue identification module 218 identifies one or more lane-level vehicle queues, the queue dynamics determination module 220 may determine which vehicles are in each identified vehicle queue. For each back of queue cluster and each front of queue cluster identified by the vehicle queue identified by the vehicle queue identification module 218, the queue dynamics determination module 220 may determine mean values of the positions of the data samples associated with each cluster. For example, FIG. 16 shows a back of queue cluster 1600 and two front of queue clusters 1602, 1604 that may be identified by the cluster analysis module 216. Each cluster may contain a plurality of data samples. The queue dynamics determination module 220 may determine mean values 1606, 1608, and 1610 associated with clusters 1600, 1602, and 1604, respectively. The queue dynamics determination module 220 may then sort the clusters by the determined mean values (e.g., in order from the rear of the sampling region to the front of the sampling region).

After sorting the clusters, the queue dynamics determination module 220 may find the position of the first back of queue cluster beginning from the rear position of the sampling region (e.g., the back of queue cluster 1600 in the example of FIG. 16). The queue dynamics determination module 220 may then find the next closest front of queue cluster (e.g., the front of queue cluster 1602 in the example of FIG. 16). The queue dynamics determination module 220 may then determine whether the vehicle IDs associated with the data samples from the selected back of queue cluster match the vehicle IDs associated with the data samples from the selected front of queue cluster. In some examples, the queue dynamics determination module 220 may determine if all of the vehicle IDs from the selected back of queue cluster match all of the vehicle IDs from the selected front of queue cluster. In other examples, the queue dynamics determination module 220 may determine if more than a threshold percentage (50%) of the vehicle IDs from the selected back of queue cluster match more than the threshold percentage of the vehicle IDs from the selected front of queue cluster.

If the vehicle IDs from the selected back of queue cluster match the vehicle IDs from the selected front of queue cluster, then the queue dynamics determination module 220 may assign the vehicles associated with the vehicle IDs from the selected back of queue cluster and from the selected front of queue cluster to the traffic jam spanning from the selected back of queue cluster to the selected front of queue cluster. If the vehicle IDs do not match, then the queue dynamics determination module 220 may find the next closest front of queue cluster (e.g., the front of queue cluster 1604 in the example of FIG. 16). The queue dynamics determination module 220 may then determine if the vehicle IDs of this front of queue cluster match the vehicle IDs of the back of queue cluster. This process may continue until each back of queue cluster is matched with a corresponding front of queue clusters and vehicles are assigned to each identified traffic jam.

After assigning vehicles to each identified traffic jam, the queue dynamics determination module 220 may estimate the position of each back of queue cluster based on the data samples associated with the cluster. In some examples, the estimated position may be a moving average. The queue dynamics determination module 220 may similarly estimate the position of each front of queue cluster. As such, the queue dynamics determination module 220 may determine the rear position and front position of each identified traffic jam.

In addition, the queue dynamics determination module 220 may estimate a speed of each identified traffic jam. In particular, the queue dynamics determination module 220 may estimate the speed of each traffic jam based on the average speed of the vehicles assigned to each traffic jam. Accordingly, the queue dynamics determination module 220 may estimate the dynamics of each traffic jam including its rear position, front position, and speed.

Referring back to FIG. 2, the data transmission module 222 may transmit information to one or more connected vehicles indicating the estimated dynamics of the identified traffic jams. In some examples, the data transmission module 222 may transmit this information to all connected vehicles within the adjusted sampling region. In some examples, the data transmission module 222 may transmit this information to all vehicles approaching the sampling region. In some examples, the data transmission module 222 may transmit this information to all vehicles within a predetermined threshold distance of the sampling region (e.g., within 1 mile). The information transmitted by the data transmission module 222 may indicate positions and speeds of the identified lane-level traffic jams.

In some examples, the data transmission module 222 may transmit the dynamics information to an autonomous vehicle, thereby causing a vehicle system of the autonomous vehicle to control the autonomous vehicle to autonomously navigate around the lane-level traffic. A vehicle system of the autonomous vehicle may then control the vehicle to follow the navigation route. This may allow the autonomous vehicle to autonomously avoid the lane-level traffic, which may increase driving efficiency.

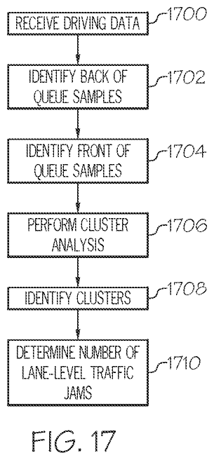

FIG. 17 depicts a flowchart of an example method that may be performed by the cloud server 104. At step 1700, the driving data reception module 212 receives driving data from one or more connected vehicles within a sampling region. As disclosed above, the driving data may include positions, speeds, and lane change activity of vehicles within the sampling region.

At step 1702, the queue sample determination module 214 identifies back of queue samples based on the received driving data. In particular, as discussed above, the queue sample determination module 214 may identify a back of queue sample when a vehicle speed drops below a threshold value.

At step 1704, the queue sample determination module 214 identifies front of queue samples based on the received driving data. In particular, as discussed above, the queue sample determination module 214 may identify a back of queue sample when a vehicle speed increases above a threshold value.

At step 1706, the cluster analysis module 216 performs cluster analysis on the identified back of queue clusters and front of queue clusters. At step 1708, the cluster analysis module 216 identifies one or more back of queue clusters and one or more front of queue clusters based on the cluster analysis. At step 1710, the vehicle queue identification module 218 determines a number of vehicle queues within the sampling region based on the identified back of queue clusters and front of queue clusters, as discussed above.

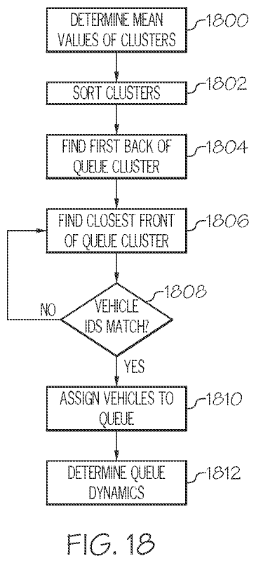

FIG. 18 depicts a flowchart of another example method that may be performed by the cloud server 104. In particular, the method of FIG. 18 may be performed by the queue dynamics determination module 220 to determine dynamics of the vehicle queues identified by the vehicle queue identification module 218.

At step 1800, the queue dynamics determination module 220 determines mean values of vehicle positions in the back of queue clusters and front of queue clusters identified by the cluster analysis module 216. At step 1802, the queue dynamics determination module 220 sorts the back of queue clusters and front of queue clusters based on their position within the sampling region.

At step 1804, the queue dynamics determination module 220 identifies the first back of queue cluster in the sampling region. At step 1806, the queue dynamics determination module 220 identifies the closest front of queue cluster in the sampling region. At step 1808, the queue dynamics determination module 220 determines whether the vehicle IDs associated with the identified back of queue cluster matches the vehicle IDs associated with the identified front of queue clusters (e.g., if more than a threshold percentage of the vehicle IDs match). If the vehicle IDs do not match (No at step 1808), then control returns to step 1806 and the queue dynamics determination module 220 identifies the next closet front of queue cluster. If the vehicle IDs do match (Yes at step 1808), then control passes to step 1810.

At step 1810, the queue dynamics determination module 220 assigns vehicles to the identified traffic jams. In particular, the queue dynamics determination module 220 may assign vehicles from the identified back of queue cluster and the identified front of queue cluster to a traffic jam spanning from the mean position of the back of queue cluster to the mean position of the front of queue cluster. At step 1812, queue dynamics determination module 220 determines dynamics of the identified traffic jams. In particular, the queue dynamics determination module 220 may determine rear positions and front positions of traffic jams based on the mean values of the back of queued clusters and front of queue clusters. The queue dynamics determination module 220 may also determine speeds of the traffic jams based on the average speeds of the vehicles assigned to the traffic jams.

It should now be understood that embodiments described herein are directed to estimating lane-level traffic jam dynamics using vehicle GPS data. By utilizing the techniques disclosed herein, dynamics of lane-level traffic may be estimated by receiving vehicle data from connected vehicles that does not include lane identification information. As such, lane-level traffic dynamics may be estimated even when lane identification information is unavailable. Locations and speeds of lane-level traffic jams may be transmitted to connected vehicles, which may then be navigated, either autonomously or by a human driver, with the knowledge of the lane-level traffic. This may improve overall traffic flow.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method comprising:
receiving driving data from a plurality of vehicles within a sampling region, the driving data including speeds, positions, and lane change activity of the plurality of vehicles;
identifying first locations of one or more back of queue samples based on the driving data;
identifying second locations of one or more front of queue samples based on the driving data;
performing cluster analysis on the first locations and the second locations;
identifying one or more back of queue clusters and one or more front of queue clusters based on the cluster analysis; and
determining a number of lane-level traffic jams within the sampling region based on the number of back of queue clusters and the number of front of queue clusters.

2. The method of claim 1, further comprising using K-means clustering to determine a number of back of queue clusters and a number of front of queue clusters.

3. The method of claim 2, further comprising performing Silhouette analysis to determine the number of back of queue clusters and the number of front of queue clusters.

4. The method of claim 1, further comprising:
fitting a plurality of Gaussian Mixture Models to the first locations and the second locations;
calculating an Akaike Information Criterion for each of the Gaussian Mixture Models;
determining the Gaussian Mixture Model having the lowest Akaike Information Criterion; and
determining a number of back of queue clusters and a number of front of queue clusters based on the determined Gaussian Mixture Model.

5. The method of claim 1, further comprising:
identifying the one or more back of queue samples where a speed of one or more of the plurality of vehicles drops below a first threshold; and
identifying the one or more front of queue samples where a speed of one or more of the plurality of vehicles increases above a second threshold.

6. The method of claim 1, wherein the number of lane-level traffic jams within the sampling region is equal to a maximum of the number of back of queue clusters and the number of front of queue clusters.

7. The method of claim 1, further comprising:
determining, based on the driving data, whether one or more of the plurality of vehicles performs a lane change at a position between one or more of the back of queue clusters and one or more of the front of queue clusters;
upon determination that one or more of the plurality of vehicles performs the lane change, determining whether a speed of the vehicle that performs the lane change remains below a threshold value within a threshold time period after performing the lane change; and
upon determination that the speed of the vehicle that performs the lane change remains below the threshold value within the threshold time period, determining that two traffic jams occur in two adjacent lanes at the location where the vehicle performed the lane change.

8. The method of claim 1, further comprising:
determining rear positions of each of the determined lane-level traffic jams based on a mean position of each of the identified back of queue clusters; and
determining front positions of each of the determined lane-level traffic jams based on a mean position of each of the identified front of queue clusters.

9. The method of claim 1, further comprising:
determining which vehicle among the plurality of vehicles is in each determined traffic jam; and
determining an average speed of each determined traffic jam based on the driving data associated with the vehicles in each determined traffic jam.

10. The method of claim 1, further comprising:
determining mean positions of each of the back of queue clusters and each of the front of queue clusters;
sorting the back of queue clusters and the front of queue clusters based on the determined mean positions;
identifying a first back of queue cluster in the sampling region based on the mean positions;
identifying a first front of queue cluster in the sampling region that is closest to the first back of queue cluster based on the mean positions;
determining whether more than a first threshold percentage of vehicles in the first back of queue clusters match more than a second threshold percentage of vehicles in the first front of queue cluster; and
upon determination that more than the first threshold percentage of vehicles in the first back of queue cluster match more than the second threshold percentage of vehicles in the first front of queue cluster, assigning the vehicles in the first back of queue cluster and the vehicles in the first front of queue cluster to a traffic jam spanning from the mean position of the first back of queue cluster to the mean position of the first front of queue cluster.

11. The method of claim 10, further comprising determining a speed of the traffic jam based on an average speed of the vehicles in the first back of queue cluster and the first front of queue cluster.

12. The method of claim 10, further comprising, upon determination that more than the first threshold percentage of vehicles in the first back of queue cluster do not match more than the second threshold percentage of vehicles in the first front of queue cluster:
identifying a second front of queue cluster in the sampling region that is next closest to the first back of queue cluster based on the mean positions;
determining whether more than the first threshold percentage of vehicles in the first back of queue clusters match more than the second threshold percentage of vehicles in the second front of queue cluster; and
upon determination that more than the first threshold percentage of vehicles in the first back of queue cluster match more than the second threshold percentage of vehicles in the second front of queue cluster, assigning the vehicles in the first back of queue cluster and the vehicles in the second front of queue cluster to a traffic jam spanning from the mean position of the first back of queue cluster to the mean position of the second front of queue cluster.

13. A computing device comprising one or more processors configured to:
receive driving data from a plurality of vehicles within a sampling region, the driving data including speeds, positions, and lane change activity of the plurality of vehicles;
identify first locations of one or more back of queue samples based on the driving data;
identify second locations of one or more front of queue samples based on the driving data;
perform cluster analysis on the first locations and the second locations;
identify one or more back of queue clusters and one or more front of queue clusters based on the cluster analysis; and
determine a number of lane-level traffic jams within the sampling region based on the number of back of queue clusters and the number of front of queue clusters.

14. The computing device of claim 13, wherein the one or more processors are further configured to:
identify the one or more back of queue samples where a speed of one or more of the plurality of vehicles drops below a first threshold; and
identify the one or more front of queue samples where a speed of one or more of the plurality of vehicles increases above a second threshold.

15. The computing device of claim 13, wherein the one or more processors are further configured to:
determine, based on the driving data, whether one or more of the plurality of vehicles performs a lane change at a position between one or more of the back of queue clusters and one or more of the front of queue clusters;
upon determination that one or more of the plurality of vehicles performs the lane change, determine whether a speed of the vehicle that performs the lane change remains below a threshold value within a threshold time period after performing the lane change; and
upon determination that the speed of the vehicle that performs the lane change remains below the threshold value within the threshold time period, determine that two traffic jams occur in two adjacent lanes at the location where the vehicle performed the lane change.

16. The computing device of claim 13, wherein the one or more processors are further configured to:
determine mean positions of each of the back of queue clusters and each of the front of queue clusters;
sort the back of queue clusters and the front of queue clusters based on the determined mean positions;
identify a first back of queue cluster in the sampling region based on the mean positions;
identify a first front of queue cluster in the sampling region that is closest to the first back of queue cluster based on the mean positions;
determine whether more than a first threshold percentage of vehicles in the first back of queue clusters match more than a second threshold percentage of vehicles in the first front of queue cluster; and
upon determination that more than the first threshold percentage of vehicles in the first back of queue cluster match more than the second threshold percentage of vehicles in the first front of queue cluster, assign the vehicles in the first back of queue cluster and the vehicles in the first front of queue cluster to a traffic jam spanning from the mean position of the first back of queue cluster to the mean position of the first front of queue cluster.

17. The computing device of claim 16, wherein the one or more processors are further configured to determine a speed of the traffic jam based on an average speed of the vehicles in the first back of queue cluster and the first front of queue cluster.

18. The computing device of claim 16, wherein the one or more processors are further configured to, upon determination that more than the first threshold percentage of vehicles in the first back of queue cluster do not match more than the second threshold percentage of vehicles in the first front of queue cluster:
identify a second front of queue cluster in the sampling region that is next closest to the first back of queue cluster based on the mean positions;
determine whether more than the first threshold percentage of vehicles in the first back of queue clusters match more than the second threshold percentage of vehicles in the second front of queue cluster; and
upon determination that more than the first threshold percentage of vehicles in the first back of queue cluster match more than the second threshold percentage of vehicles in the second front of queue cluster, assign the vehicles in the first back of queue cluster and the vehicles in the second front of queue cluster to a traffic jam spanning from the mean position of the first back of queue cluster to the mean position of the second front of queue cluster.

19. A system comprising a computing device and a plurality of vehicles, wherein:
the plurality of vehicles are configured to transmit driving data to the computing device, the driving data including speeds, positions, and lane change activity of the plurality of vehicles; and
the computing device comprises one or more processors configured to:
receive the driving data from the plurality of vehicles within a sampling region;
identify first locations of one or more back of queue samples based on the driving data;
identify second locations of one or more front of queue samples based on the driving data;
perform cluster analysis on the first locations and the second locations;
identify one or more back of queue clusters and one or more front of queue clusters based on the cluster analysis; and
determine a number of lane-level traffic jams within the sampling region based on the number of back of queue clusters and the number of front of queue clusters.

20. The system of claim 19, wherein the one or more processors are further configured to:
identify the one or more back of queue samples where a speed of one or more of the plurality of vehicles drops below a first threshold;
identify the one or more front of queue samples where a speed of one or more of the plurality of vehicles increased above a second threshold;
determine, based on the driving data, whether one or more of the plurality of vehicles performs a lane change at a position between one or more of the back of queue clusters and one or more of the front of queue clusters;
upon determination that one or more of the plurality of vehicles performs the lane change, determine whether a speed of the vehicle that performs the lane change remains below a threshold value within a threshold time period after performing the lane change; and
upon determination that the speed of the vehicle that performs the lane change remains below the threshold value within the threshold time period, determine that two traffic jams occur in two adjacent lanes at the location where the vehicle performed the lane change.
